(19) United States
(12) Patent Application Publication
(10) Pub. No.: US 2004/0078424 A1
(43) Pub. Date: Apr. 22, 2004

(54) Web services via instant messaging

(75) Inventors: Rahav Yairi, Arlington, MA (US); Michael Mahan, Tyngsboro, MA (US)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/270,574

(22) Filed: Oct. 16, 2002

(51) Int. Cl. G06F 15/16

(52) U.S. Cl. 709/203; 709/206; 709/246

(57) ABSTRACT

A method and system for accessing one or more web services (WS) from a mobile terminal using an instant messaging (IM) client are provided. Each web service appears to the IM client as a virtual IM user with whom the IM client can communicate. When the IM client requests to communicate with a web service virtual user, the IM message is routed through a mobile IM server to an IM/WS gateway, which obtains a description of the requested web service, prompts the IM client for any required web service input, and composes a web services formatted message to send to the web services provider. When the IM/WS gateway receives a response back from the web service, the IM/WS gateway translates the response into one or more IM messages and sends the IM message(s) to the requester IM client. The IM/WS gateway can combine web services to provide a higher value service to an IM user. The operator's value added services, such as billing and location, can be used in these types of composite services.

### FIELD OF THE INVENTION

The invention relates generally to mobile telecommunications services. More specifically, the invention provides web services over an instant messaging application to wired and wireless data processing devices.

### BACKGROUND OF THE INVENTION

Mobile telephones and other wireless devices are quickly becoming an integral part of business and personal communications. To accommodate this trend, mobile telecommunications companies are presently developing and launching new generations of mobile telecommunications networks, such as 2.5 G and 3 G networks, which allow faster data communications speeds for wireless devices. These faster data communication speeds allow devices to exchange files, email, instant messaging (IM) messages, short message service (SMS) messages, and other data without the lengthy delays typically associated with prior telecommunications networks. In addition, these devices allow users to browse the World Wide Web (WWW) over the Internet with little latency.

One aspect of Internet use that mobile devices have not yet taken advantage of is application-to-application communications (as opposed to browsing the WWW). Programmatic interfaces made available for application-to-application communication over the Internet are referred to as web services. For example, an application (e.g., QUICKEN® by Intuit Inc.) on a client desktop computer may send over the Internet a request for a stock quote to a stock quote application server. The stock quote application server then sends the requested stock quote back to the QUICKEN® application running on the client computer, all without requiring a user to open and/or navigate a web browser. Previously, web services have targeted traditional computers such as desktop and portable computers. However, with the emergence of faster wireless networks, web services will be more readily accessible by mobile devices if webs services are made readily available by developers to end users.

Mobile devices such as mobile telephones have not made widespread use of web services for reasons including that discovery of and access to web services can be complex. In order to effectively discover (i.e., retrieve sufficient web service metadata to effectuate communications) and communicate with a web service, a client device must have sufficient dynamic memory, persistent memory (to store the client application program that parses web service communications, interacts with the user, provides software bindings, etc.), data bandwidth, and processing power. In addition, the client device must be able to understand emerging web services standards, such as encoding and decoding extensible markup language (XML) documents and creating and consuming simple object application protocol (SOAP) messages. Lower end mobile devices are often resource-constrained and do not meet these requirements.

Even if a device has the necessary resources, web services generally do not provide a common interface. Thus, for each web service that a user wants to access, the user must obtain and install a new client-device application program specific to the desired web service. As mobile devices have limited persistent storage, installation of multiple web services' client-device application programs will quickly consume the persistent storage of the mobile device. In addition, client software on many mobile devices is immutable. That is, there is little (if any) opportunity to modify the software after the mobile device is delivered to the user. Thus, if a web service provider alters a provided web service, a user of the mobile device must obtain and install new software. Even if software on a mobile device could readily be modified, a user may still view the process as tedious and time-consuming, and as a result decide not to continue using that particular web service, or decide not to upgrade the software.

In addition to the above, web services typically do not provide a simple payment mechanism. That is, prior web service billing solutions require a user to input billing information for each web service, and sometimes for each transaction with a web service. Because mobile devices often provide limited input capabilities, requiring a user to input billing information (e.g., credit card, name, address, etc.) for each web service and/or transaction is a prohibitive factor when a user is deciding whether or not to use a web service. Additionally, since web services consumed by mobile phones will often be of small or micro amounts, credit cards might not be the optimal payment solution.

One prior solution that allows a mobile device to access and pay for web services is the use of SMS messages to access a network service. However, using SMS messages for network services requires an operator to provide a custom mapping translation model for each network service provided. That is, the network operator must convert messages from the SMS model to the network service provider's processing model. This task requires human intervention in the form of man-hours of labor for each new network service. In addition, activating network services using SMS messages may be difficult because a user (or application program) is required to format each SMS message according to a specific format, and the user must remember or store an arbitrary telephone number for each network service she desires to access via SMS. Furthermore, SMS provides no service discovery or description capabilities, so a user does not have an automated means for learning about new network services, and there is no generic access mechanism for those network services that the user does know about.

Thus, it would be an advancement in the art to provide a generic mechanism through which a resource-constrained device such as a mobile telephone can discover and communicate with multiple web services. It would be a further advancement in the art if the generic mechanism reduced the overhead required by a mobile device to access multiple web services than the overhead required by previous solutions (i.e., unique client-device application for each web service). It would be a further advancement in the art to provide a simple payment mechanism for web services so that users are not required to enter payment information multiple times.

### BRIEF SUMMARY OF THE INVENTION

The present invention overcomes the problems and limitations of the prior art described above, as well as other problems and limitations that will become apparent to the reader, by using an instant messaging (IM) client on a mobile terminal, and corresponding instant messaging technology and existing architecture, to access one or more web services. Each web service is represented to the user as a virtual IM user. By using uniform IM technology, the invention negates the need for multiple client applications on each mobile terminal. The invention also provides for service provisioning, service aggregations (i.e., automatic combination of distinct services when applicable) and value added services such as billing, presence, and authentication.

According to a first aspect of the invention, a gateway data processing device acts as an intermediary between IM users and web services. The gateway communicates with an instant messaging (IM) server via a first network interface, and communicates with a plurality of web service providers through a second network interface. The gateway stores a database of information on the available web services, such as communication details, required inputs, expected outputs, and the like. The gateway also includes a proxy module that translates messages between formats understandable by IM users and each web service. When the proxy receives from an IM user an IM-formatted request for a web service, the proxy retrieves information from the database corresponding to the requested web service, and generates one or more web service-formatted request(s) corresponding to the requested web service using the retrieved information. Upon creation of the web service formatted message, the proxy sends the web service-formatted request(s) to a specific web services provider that provides the requested web service. One or more web service response(s) is received by the proxy, reformatted for the IM system, and delivered to the IM server destined to the originating mobile IM user.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a wireless telecommunications network adapted according to an illustrative embodiment of the invention.

FIG. 2 illustrates a block diagram of a mobile terminal according to an illustrative embodiment of the invention.

FIG. 3 illustrates a method for a mobile terminal to communicate with web services according to an illustrative embodiment of the invention.

FIG. 4 illustrates a screenshot of an instant messaging (IM) client on a mobile terminal according to an illustrative embodiment of the invention.

FIG. 5 illustrates another screenshot of an IM client on a mobile terminal according to an illustrative embodiment of the invention.

FIG. 6 illustrates another screenshot of an IM client on a mobile terminal according to an illustrative embodiment of the invention.

FIG. 7 illustrates another screenshot of an IM client on a mobile terminal according to an illustrative embodiment of the invention.

FIGS. 8A-8C illustrate screenshots of an IM client on a mobile terminal during a human intervention process according to an illustrative embodiment of the invention.

FIG. 9 illustrates a SOAP message from an instant messaging web services (IM/WS) gateway to a web services provider according to an illustrative embodiment of the invention.

FIG. 10 illustrates a SOAP message from a web services provider to an IM/WS gateway a according to an illustrative embodiment of the invention.

FIGS. 11A-11E illustrate screenshots of an IM client on a mobile terminal during a discovery process according to an illustrative embodiment of the invention.

### DETAILED DESCRIPTION OF THE INVENTION

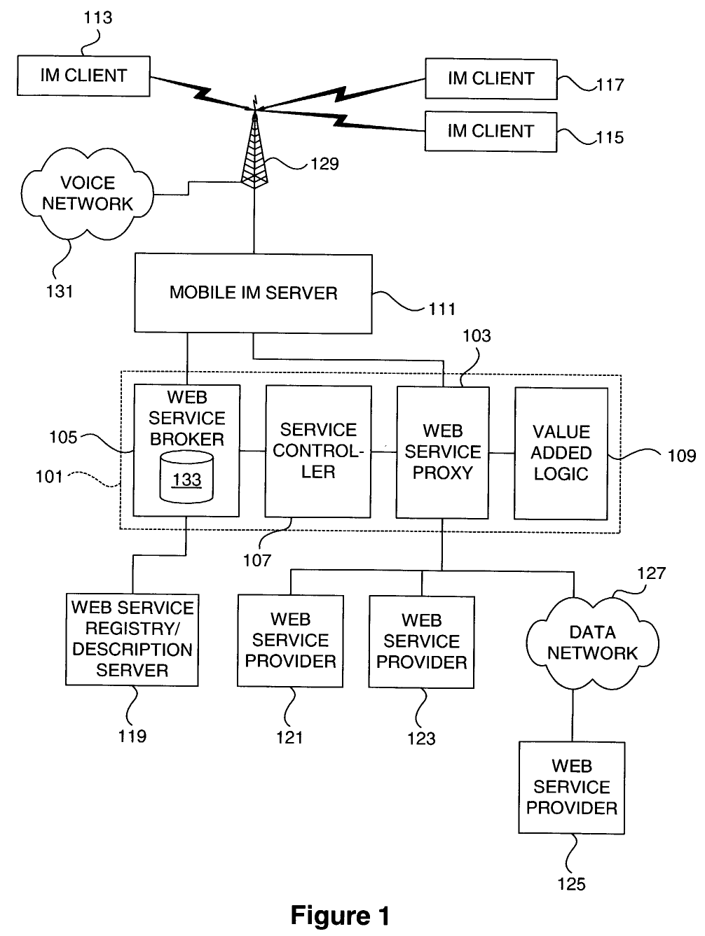

FIG. 1 illustrates a block diagram of a wireless communications network adapted to allow mobile terminals to use an instant messaging (IM) service (e.g., AOL Instant messaging, MSN Messenger, and Yahoo! Messenger) to access one or more web services. Mobile terminals 113, 115, and 117 wirelessly communicate over voice network 131 via one or more base stations 129, as is known in the art. Each mobile terminal 113, 115, and 117 has stored in memory an embedded IM client application. The IM client application allows a user of the mobile terminal to engage in conversation with one or more other IM users via mobile IM server 111, as is known in the art. The term IM user, as used herein, refers to an operator of a mobile terminal using an IM client embedded in the mobile terminal, and should be construed broadly to encompass both or either of the IM client software and the end-user. Mobile IM server 111 routes IM messages between mobile users. That is, when a mobile terminal, e.g., mobile terminal 113, sends an instant message to a user associated with another mobile terminal, e.g., mobile terminal 117, the instant message is routed through mobile IM server 111 to mobile terminal 117.

However, when an instant message is directed to a web service, as described herein, the instant message is routed through the mobile IM server 111 to an Instant Messaging Web Services (IM/WS) Gateway 101 for further processing and delivery to a web service provider, such as web service provider 121, 123, or 125. IM/WS gateway 101 includes a web services proxy module 103, web services broker module 105, service controller (SC) 107, and value added logic (VAL) module 109. IM/WS gateway 101 may be a network server or other computer with software adapted to perform as described herein, and that includes one or more network interfaces. Alternatively (not shown), IM/WS gateway 101 and mobile IM server 111 may be combined and their functions performed by a single device. IM/WS gateway 101 may be directly connected to a web services provider 121, 123, or connected through a data network 127, e.g., the Internet, to one or more web services providers 125. IM/WS gateway 101 may also be connected to a web service registry and description server 119. One of skill in the art will appreciate that the IM server, the IM/WS Gateway, and various Web Services can be accessed either by a private network, a public network, or bundled together on the same machine. The permutations are open-ended and, as such, and combination of public and private networks can be used to access each device/service.

Using the above-described architecture, IM/WS gateway 101 acts as a mediator between each web service provider and each user accessing the web service via an IM client. IM/WS gateway 101 manages “virtual” accounts for each web service to make each web service appear to IM server 111 as a conventional IM user (i.e., an IM client associated with a human user). Each web service can thus appear to conventional users as a contact within the embedded IM client on the user's mobile terminal, just as other conventional users appear as contacts within the embedded IM client. In addition, by allowing users to access web services using an IM client, users can use a familiar user interface for accessing multiple web services without having to learn a new user interface for each web service the user desires to access. Using IM primitives, new web services can be introduced to the user, the user can store references (e.g., as a “buddy”) to services so that the user does not have to repeat the discovery process each time the user wants to access a web service, and the user can activate the service by initiating an IM to the web service. In addition, because the same IM client is used to access each web service, the user does not need to switch applications to access a new web service, thus making the user interface simple and intuitive to use. The IM client may also support initiating a web service session either from the client (pull model) or from the IM/WS gateway 101 (push model).

IM/WS gateway 101 may include the following modules: web service proxy 103, web service broker 105, service controller (SC) 107, and value added logic module 109. Generally, web service proxy 103 is responsible for translating messages between IM format and each web service's format. Web service broker 105 is responsible for advertising, discovery, and managing available web services. SC 107 is responsible for the runtime logic flow for both singleton and composite web services, and value added logic module 109 is responsible for services such as billing, authentication, and the like. One of skill in the art will appreciate that more or fewer modules may be used to perform the same or similar functions. In addition, some value added services may be provided by an external network provider, e.g., location determination and billing functions may be provided by a wireless network operator. Each module is described in more detail below.

Web service broker module 105 provides registration and discovery for web services accessed through IM/WS gateway 101, and stores in database 133 any data needed for the interaction between the end user and a requested web service. The stored data may include web service description metadata, web service composition metadata, or web service workflow logic. The stored data may additionally include program control logic, payment information, or any other information about the web service or web service provider that may be presented to the user, e.g., during web service discovery or activation. This stored data may subsequently be referred to either collectively or specifically as web service metadata or simply as metadata.

Registration, generally, is the process through which web service broker 105 learns about new web services, e.g., how to interact with each new web service. Web service broker 105 may automatically access descriptions stored in a web service registry/description service 119 using one or more web service discovery protocols, e.g., Universal Description, Discovery, and Integration (UDDI) and WS-Inspection protocols. Alternatively, web service descriptions may be made available to web service broker 105 through a programmatic interface or custom configured for the IM/WS gateway. Web service descriptions may be in the form of a web services description language (WSDL) document. However, any other description format, such as a UDDI T-Model description, may alternatively be used. Web service broker 105 may store web service metadata in web services database 133. In addition, as part of the registration process, web service broker 105 assigns an IM user ID to each new web service. Web service broker 105 may communicate with one or more IM servers 111 to obtain and assign the IM user ID.

Discovery, generally, refers to the ability of an IM client to learn about new web services. The IM client may learn about new web services when requested by a user for a specific web service (e.g., traditional pull model), or when web service broker 105 pushes new web service provider information to the IM client in response to a general request by the IM client or automatically. Web service broker 105 may itself appear to a client IM user as just another typical IM user, e.g., named “Service Finder.” Thus, the client IM user can request information on new web services by initiating a session with the user named “Service Finder.” In addition to initiating a session with web service broker 105, an IM client may specify search criteria. Web service broker 105 then locates any new and/or existing web services meeting the specified criteria, and pushes the information back to the IM client.

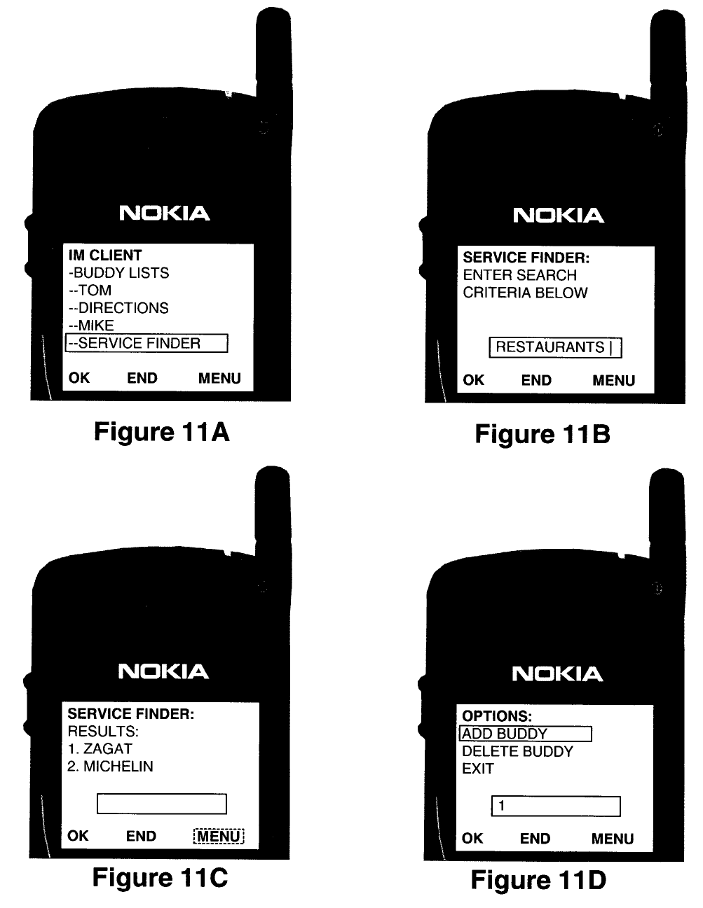

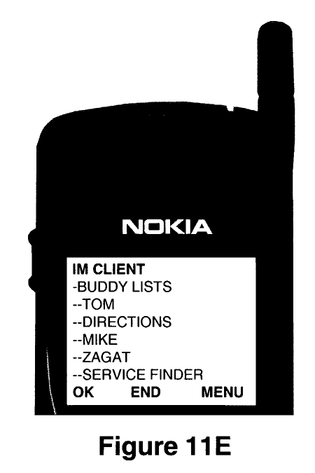

FIGS. 11A-11E illustrate screenshots as an IM client discovers new web services and adds a corresponding buddy to a buddy list. In FIG. 11A a user selects and initiates a conversation with a buddy named “Service Finder.” In FIG. 11B the user enters information corresponding to the type of service the user desires to locate, for example, restaurants. FIG. 11C illustrates the web service broker's response to the IM client on the mobile terminal, indicating that Michelin and Zagat restaurant web services are available, and illustrates the user requesting menu options by selecting “Options.” In FIG. 11D the user requests to add the Zagat web service to his or her buddy list, resulting the buddy list illustrated in FIG. 11E.

Alternatively, web service broker 105 may automatically push information regarding new web services to an IM client without waiting for a request from the IM client. In such a scenario, the IM client may receive a message indicating that user “Service Finder” has sent the IM client a message. Upon opening the contents, the IM client learns of the new web service and can add the web service to a buddy list, if desired. Still alternatively, the IM client may receive a message from the actual new web service, requesting the IM client to add the web service as a buddy to a buddy list. For web services described using WSDL documents, the <documentation> element contained in the <service> element may be used for the buddy description, and the name of the <service> element may be used as the name of the buddy. In this embodiment, the web service is not required to know the IM ID of the user in order to push the request to the IM client.

Web service broker 105 has an interface that allows the service controller 107 to obtain a corresponding service description when passed an IM user ID of a particular web service by an embedded IM client. In one embodiment of the invention, service metadata is localized in one place (e.g., the database), thus removing the need for synchronization. If a service provider changes the metadata relating to a provided web service, then the IM/WS Gateway operator can simply remove this IM user/service from the system and let the service provider re-register the web service.

Once an embedded IM client in a mobile terminal (e.g., mobile terminal/IM client 113) learns about a web service (e.g., web service 125), web service proxy module 103 facilitates communications between the embedded IM client 113 and the web service 125 based on the data obtained by web service broker 105. As indicated above, the web service 125 appears to the IM client 113 as a “virtual” IM user. Generally, the IM client 113 sends a message through the mobile IM server 111 to the web service proxy 103. The service controller 107 determines the service description used by the web service (e.g., by retrieving the web service's corresponding metadata from database 133), obtains any necessary parameters from the IM client 113, translates the information into a message format understandable by the web service 125, and forwards the message to the requested web service 125. Upon receiving the response from the web service 125, the web service proxy 103 translates the message into IM messages understandable by the IM client 113, and forwards the message to the requesting IM client 113. Note that the web service proxy provides the role of a stateless, data format translator between the IM and web services protocols. The service controller 107 contains the logic which drives the service invocation behavior of the gateway.

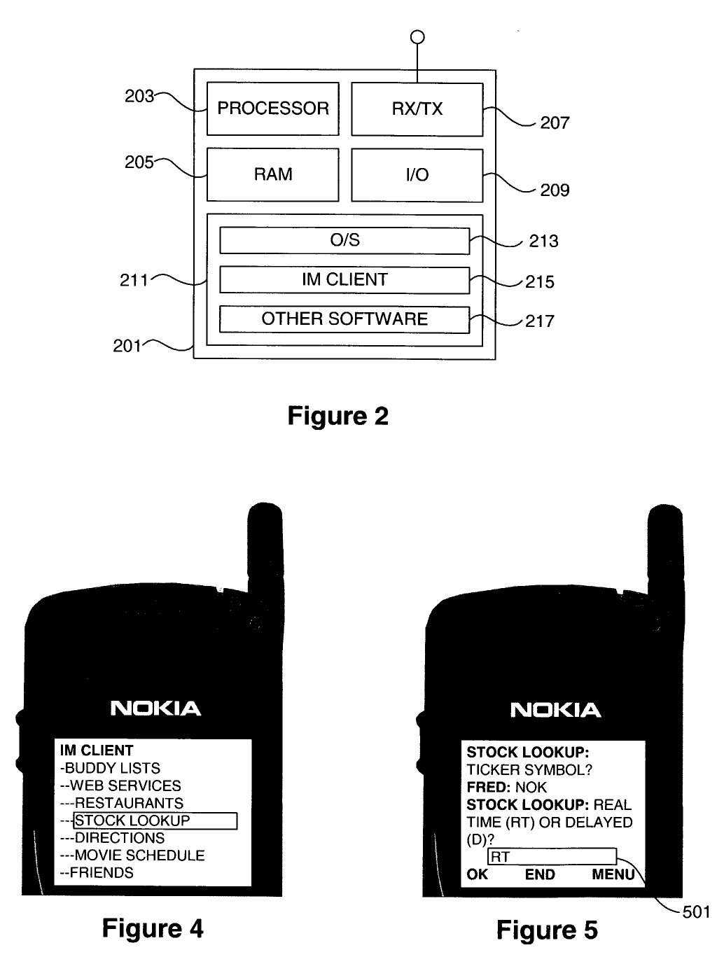

SC 107 can combine multiple web service functions to provide enhanced services to IM clients. For example, a Restaurant Finder web service may provide the address for the nearest restaurant meeting user-specified criteria, such as the nearest Chinese restaurant. A second web service may provide driving directions from one location to a second location. In order to find the nearest Chinese restaurant as well as obtain directions to the location of the restaurant, a user ordinarily must first request the location from the Restaurant Finder web service, and then request driving directions from the second web service, including inputting the starting and ending locations. SC 107 acts in place of the requesting IM client, to obtain from a driving directions web service, the driving directions to the restaurant. Service controller 107 may obtain the starting address from global positioning system (GPS) information received from the requesting mobile terminal, when available. Alternatively, the service controller may obtain an approximate location of the mobile terminal based on the wireless cell through which the mobile terminal is connected, and optionally a more specific location based on signal triangulation techniques (e.g., angle of arrival (AOA), time difference of arrival (TDOA), etc.), as are known in the art. If no such location identification mechanism is available, or if the user wants to get directions from another location, the user can manually input the starting location through the IM client, as described below with reference to FIG. 2. Other composite services that may be provided include obtaining mass transit schedules based on the location of the mobile terminal and the time of the request, and alerting to traffic information subsequent to providing driving directions (optionally further based on a location of the mobile terminal).

Value added logic (VAL) module 109 provides ancillary service access that may be common to or requested by multiple web services. Value added services may include billing, authentication, automatic notifications to a user (e.g., calendar/schedule notifications), obtaining mobile terminal location information for use by the service controller (described above), and the like.

Because many web services are expected to cost a fraction of a dollar (or cent) per use or transaction, it may be economically inefficient for web services providers to individually bill users for each session. Web services providers can accumulate charges prior to billing, but there is still considerable overhead required by a web services provider in order to set up billing and accounts receivable functions. Thus, the operator-owned billing module, accessed through VAL module 109, allows web service providers to submit a payment record to be handled by the wireless network operator instead of individual IM clients. VAL module 109 can add charges to the bill of an owner of a mobile terminal, thus allowing the wireless operator to act as a clearinghouse for web services charges. Optionally, VAS module 109 may wait until a user's charges have exceeded a minimum threshold before billing the user, and may wait until monies owed a web service provider exceed a minimum threshold before paying the web service provider.

FIG. 2 illustrates a block diagram of a mobile terminal (MT) 201 adapted to communicate with web services using an embedded IM client. Mobile terminal 201 may be a mobile telephone, personal digital assistant (PDA), personal communication device such as the Nokia Communicator available from Nokia Corp. of Helsinki, Finland, or any combination or other mobile device with integrated wireless telecommunications capabilities. Mobile terminal 201 may include a processor 203, RAM 205, transceiver 207, I/O 209, and nonvolatile memory 211. I/O 209 may include one or more input and/or output device such as input buttons, microphone, digital camera, speaker, display screen, and the like. Transceiver 207 is used to communicate with one or more wireless networks (e.g., network 125 and/or network 131 via base station 129 in FIG. 1), and may include multiple communication mode capabilities, e.g., analog, digital (GSM, CDMA, etc.).

Nonvolatile memory 211 may store operating system software 213, instant messaging (IM) client software 215, and other software 217. IM client software 215 allows the user to communicate with other users, optionally stored in one or more “buddy” lists as are known in the art, and to communicate with web services, which may appear as a named buddy in one or more buddy list. Other software 217 may include software for performing other mobile terminal operations, such as GPS software, phonebook, calendar, web browser, email client, and the like.

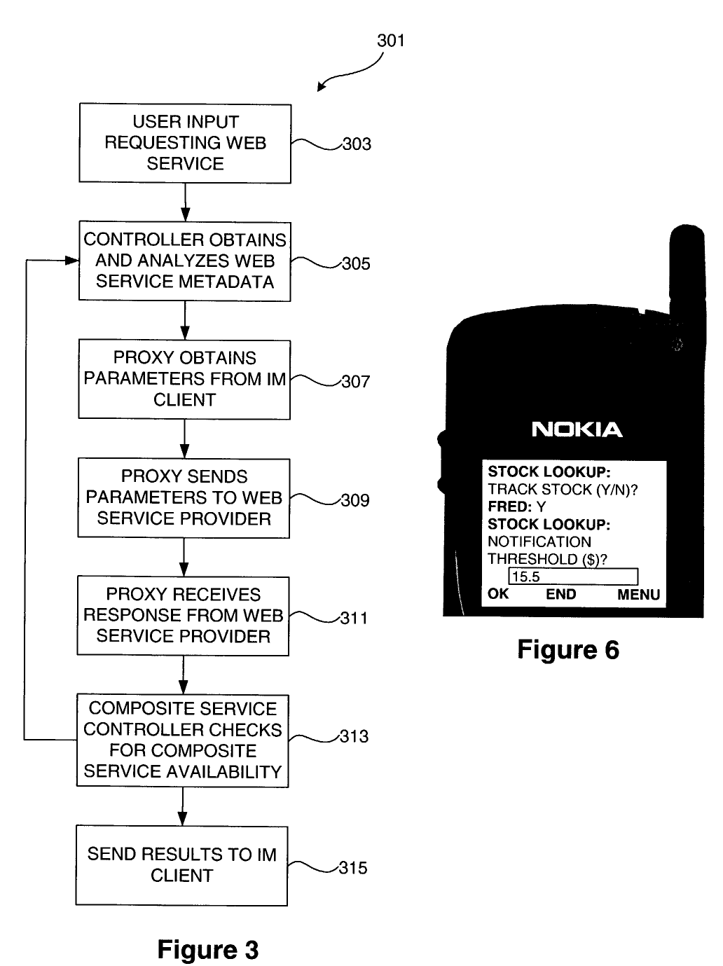

With further reference to FIGS. 3-5, a method 301 for a mobile terminal (MT) having an embedded IM client to communicate with and receive information from a web services provider, is now described. Initially, in step 303, mobile terminal 201 receives user input indicating that the user desires a connection with a specific web service, e.g., web service 125, in order to receive some desired information. FIG. 4 illustrates a screenshot of an IM client application 215 after a user has navigated and selected a buddy corresponding to a stock ticker symbol web service.

Web service controller 107 in step 305 obtains the description metadata corresponding to the selected web service from web service database 133, and analyzes the metadata to determine parameters that web service proxy 103 needs to obtain from IM client 211 in step 307 prior to sending a message to the web service provider in step 309. The web service metadata may indicate that web service proxy 103 only needs to send a single message to a web service provider with a single input parameter, or may indicate that multiple messages and/or multiple input parameters are needed. In addition, in step 305 web service controller 107 determines whether a composite service was requested, or whether a composite service is available and can be offered to the user as a follow-up option. Composite services can be described using known protocols such as web services flow language (WSFL). WSFL is an XML language for describing web services compositions as part of a business process definition, as is known in the art.

For example, web service controller 107 obtains the web service metadata associated with the stock lookup web service from web service broker 105 and more specifically from web service database 133. When a WSDL description document is available, proxy 103 may identify the offered web service by the <operation> element. The obtained metadata may further indicate (by looking up the WSDL <part> element) that the stock lookup web service requires two parameters: ‘symbol’ and ‘quote_type’. Symbol may be used to store the ticker symbol of the requested stock quote, and quote_type may be used to indicate whether the user desires a delayed quote (less expensive) or real time quote (more expensive). Web service controller may also determine that a composite service is offered with the stock lookup web service, e.g., auto notification when the requested stock's value reaches a predetermined threshold value.

In step 307 web service proxy 103 obtains the required parameters from IM client 215 by communicating with IM client 215 under the name of the web service. That is, interaction with web proxy 103 will appear to the user to be similar to chatting with another user. Web service controller 107 may use a common algorithm to retrieve the required input from the IM client. For each input parameter defined by the web service metadata, web service controller 107 prompts the IM client (and hence the user) for the required input. When a WSDL description document is available, the web service controller 107 may use the <part> element of the <message> element as the prompt text for the IM client to display to the user. The <message> element is related to the <input> element contained within the <operation> element as defined by the WSDL metadata. After obtaining a response from the user, web service controller 107 proceeds to the next <part> element until all the required parameters have been obtained. FIG. 5 illustrates user interaction with the IM client based on the queries from the web service proxy 103. FIG. 5 further illustrates a sample user interface for a user to input information into an IM client. The user can use a keypad or other input devices (not shown) of the mobile terminal to type into text box 501. The user can submit the entered data by pressing a button or other input device associated with the ‘OK’ option illustrated on the mobile terminal. Alternatively, the user could terminate the web service session by pressing a button or other input device associated with the ‘END’ option. The user may obtain an options menu (e.g., help, settings, etc.) by pressing a button or other input device associated with the ‘MENU’ option.

While FIG. 5 illustrates a user providing each requested parameter's input value, in alternative embodiments one or more parameters may be determined automatically. For example, IM client 215 may store basic personal data about the IM user using the IM client. When a query is received asking for information stored in the personal data, the IM client may automatically generate the response using the stored value. Also, the IM client may obtain a stored value from a source within the mobile terminal, e.g., a GPS module. When a web service queries for the location of the user of the IM client, the IM client may automatically obtain the location from the GPS module and use the obtained location as the response value.

If the user (via IM client) requests a composite service, then SC 107 may oversee interaction with the IM client to obtain all the necessary parameters in order for the combined service to be performed. For example, a house hunting composite service might combine a house-for-sale-service with a mortgage-service. The parameters needed for the combined service might be a desired location (e.g., Boston), mortgage type (e.g., 30 years fixed), and the monthly payment willing to pay.

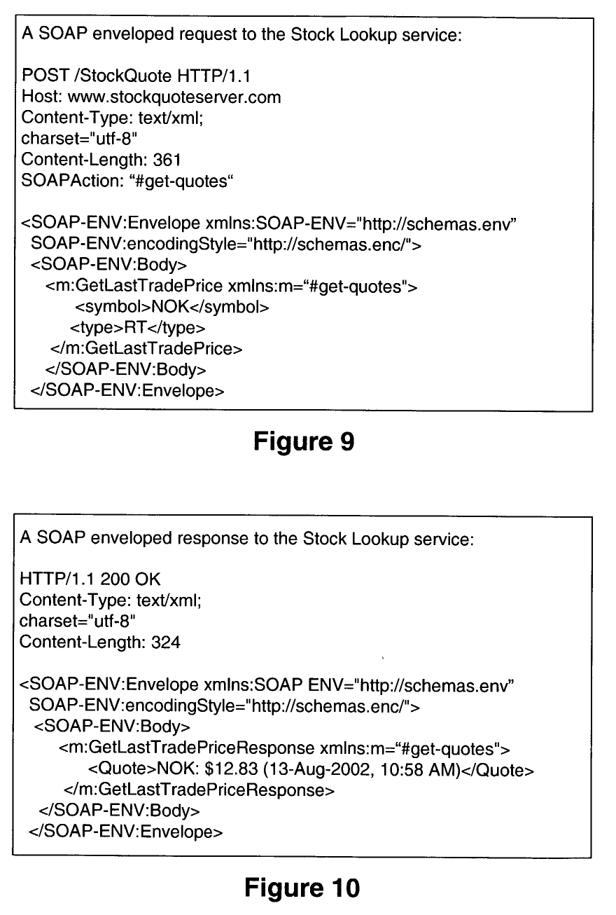

In step 309, web service proxy 103 composes a message including the obtained parameters and sends the message to the corresponding web service provider, e.g., web service provider 125. Web service proxy 103 may construct the message as a SOAP message according to the web service's corresponding metadata obtained from database 133. In step 311 web service proxy 103 receives a web service SOAP response from web service provider 125. FIGS. 9 and 10 illustrate sample SOAP messages that may be sent to and received from web services provider 125, respectively.

In step 313 SC 107 may again determine whether a composite service has been requested and, if not, whether one is available to the user. When a composite service has been requested, SC 107 may repeat steps 305-311 as necessary to obtain the composite service information.

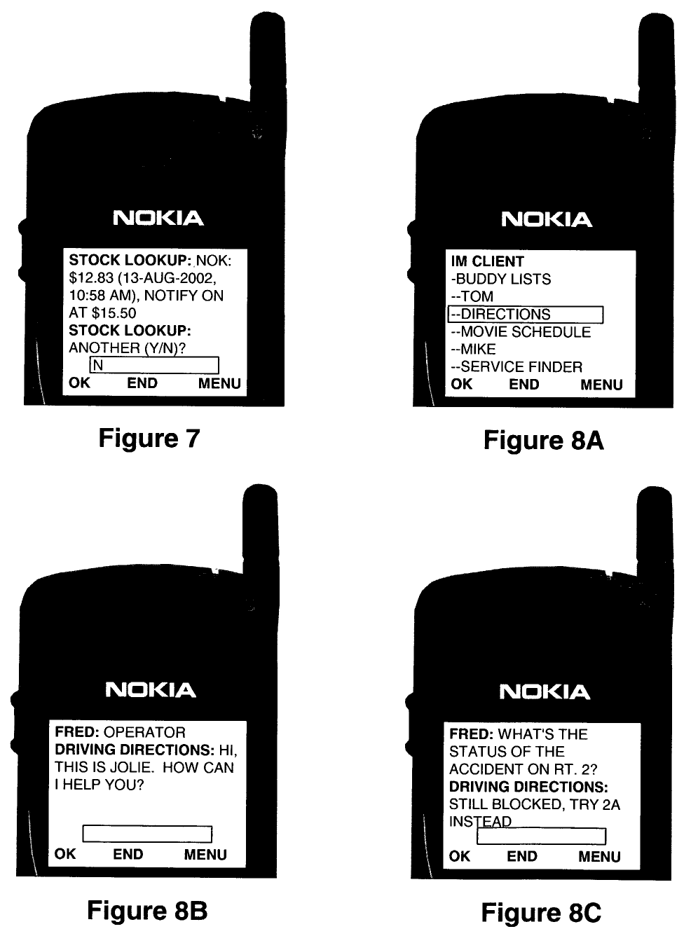

In step 315, web service proxy 103 provides the web service results to the IM client for display to the user, as illustrated in FIG. 7. The results may be sent as one or more IM messages from the virtual user “Stock Lookup.” In FIG. 7 the IM client displays the requested stock quote.

It will be appreciated by one of skill in the art that one or more steps may be optional. For example, in systems that do not offer composite service features, steps relating to composition tasks of SC 107 may be omitted. In addition, steps may be performed in other than the recited order. For example, SC 107 might not query the user regarding optional composite services until after the web service proxy 103 sends the web service results to the IM client, as the user may need know the results of the web service inquiry before deciding whether to use the composite service.

In addition to providing broker, proxy, composite, and value added logic, IM/WS gateway 101 may further be adapted to provide support services as well. For example, web services proxy 103 may provide customer support services including online help, language support and translation, human help support to web services, and the like. Human help support refers to a situation where an automated web service either does not provide a result or does not provide a result with which the requesting user is satisfied. In such a scenario, the user may send a message to the web service that indicates that human intervention is requested, e.g., by typing the message “operator”. Proxy 103 can recognize this, and forward messages back and forth between the IM client and the web service provider's human operator. FIGS. 8A-8C illustrate various IM client screenshots when a user has requested human intervention by a web service provider, and interacts with a human operator of the web service provider.

In addition, for large requests, web services proxy 103 may monitor the status of a request and provide feedback to the user, such as “Processing 80% complete,” “Authenticating . . . ,” and the like.

As stated above, IM/WS gateway 101 may be a conventional network server or other computer device. While four primary modules are described above, the modules are representative of functions that IM/WS gateway 101 performs. More or fewer modules may alternatively be used to perform the same functions. The modules may be comprised of computer executable instructions, e.g., one or more software applications, stored on a storage device or computer readable medium, such as a hard disk, optical disk (CD, DVD), floppy disk, tape, or the like, of gateway computer 101.

Thus, by adding the above-described gateway to the network and capabilities to a mobile terminal, a network operator can offer web service access, such as access to standards based web services such as use XML and/or Java (or other Java-based languages), to mobile terminals using many existing IM components and existing IM architecture. While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I/We claim:

1. A device, comprising:
a database that stores information corresponding to a plurality of web services; and
a proxy module that receives from an instant messaging (IM) user an IM-formatted request for a web service, generates a web service-formatted request corresponding to the requested web service based at least on the IM-formatted request and on information corresponding to the requested web service stored in the database, and sends the web service-formatted request to a specific web service provider that provides the requested web service.

2. The device of claim 1, wherein the proxy module, upon receiving a web service-formatted response from the specific web service, generates an IM-formatted response based on the web service-formatted response, and sends the IM-formatted response to the IM user.

3. The device of claim 1, wherein the information stored in the database comprises metadata describing how to communicate with each web service.

4. The device of claim 3, wherein the information stored in the database is based on a web services description language (WSDL) document.

5. The device of claim 3, wherein the information stored in the database is based on a universal description, discovery, and integration (UDDI) document.

6. The device of claim 1, wherein the proxy module generates the web service-formatted request by querying the IM user for input based on the information corresponding to the requested web service stored in the database.

7. The device of claim 6, wherein the proxy module queries the IM user by sending one or more IM-formatted messages to the user, wherein each IM message requests an input required by the requested web service as indicated by the information corresponding to the requested web service stored in the database.

8. The device of claim 1, further comprising a broker module that receives information corresponding to a new web service being offered, and stores the information corresponding to the new web service in the database.

9. The device of claim 8, wherein the broker module sends to the IM user an IM-formatted message communicating the existence of the new web service.

10. The device of claim 1, further comprising a value added logic module for accessing a value added service provided by the network operator.

11. The device of claim 10, wherein said value added service comprises billing.

12. The device of claim 10, wherein said value added service comprises authentication.

13. The device of claim 10, wherein said value added service comprises determining the location of a mobile terminal corresponding to the IM user.

14. The device of claim 1, further comprising a service controller module for providing control flow and service composition logic.

15. The device of claim 3, wherein the information stored in the database comprises Java-based code.

16. The device of claim 3, wherein the information stored in the database comprises data based on a service metadata standard.

17. The device of claim 10, further comprising a service composition module for providing a second web service based in part on the requested web service.

18. The device of claim 17, wherein the second web service comprises determining the location of a mobile terminal corresponding to the IM user, and
wherein the second web service comprises providing directions to a location provided by the requested web service from the determined location of the mobile terminal.

19. The device of claim 6, wherein the proxy module queries the IM user by sending an IM-formatted messages to the user for each input element defined by a WSDL document corresponding to the requested web service.

20. A method for providing access to multiple web services by a mobile terminal, comprising:
(i) receiving from a mobile terminal an IM-formatted request for a requested web service;
(ii) retrieving information corresponding to the requested web service from a web services database;
(iii) generating a web service-formatted request corresponding to the requested web service, wherein the generation is based at least on the retrieved information; and
(iv) sending the web service-formatted request to a specific web services provider providing the requested web service.

21. The method of claim 20, further comprising:
(v) receiving a web service-formatted response from the requested web service;
(vi) generating an IM-formatted response based on the web service-formatted response; and
(vii) sending the IM-formatted response to the mobile terminal.

22. The method of claim 20, wherein step (iii) comprises querying the mobile terminal for input based on the information corresponding to the requested web service retrieved from the database.

23. The method of claim 21, further comprising providing a second web service based in part on the web service-formatted response received from the requested web service.

24. A mobile terminal, comprising:
a processor;
an input device;
a display screen;
memory storing computer readable instructions that, when executed by the processor, perform a method for communicating with a plurality of web services, comprising
(i) sending to an instant messaging web services gateway an instant messaging (IM) formatted request to communicate with a predetermined web service in the plurality of web services;
(ii) receiving an IM-formatted query message from the gateway for each input required by the predetermined web service;
(iii) generating an input value for each input required by the predetermined web service;
(iv) sending an IM-formatted response message to the gateway for each determined input value; and
(v) receiving an IM-formatted web service response from the gateway based on each of the sent input values.

25. The mobile terminal of claim 24, wherein step (iii) comprises receiving the input value from a user.

26. The mobile terminal of claim 24, wherein step (iii) comprises receiving the input value from a global positioning system (GPS).
